(19) United States
(12) Patent Application Publication
(10) Pub. No.: US 2018/0321736 A1
(43) Pub. Date: Nov. 8, 2018

(54) BEAM GUIDING DEVICE

(71) Applicant: INTEL CORPORATION, Santa Clara, CA (US)

(72) Inventor: Jonathan Masson, Pully (CH)

(73) Assignee: INTEL CORPORATION, Santa Clara, CA (US)

(21) Appl. No.: 15/585,481

(22) Filed: May 3, 2017

(51) Int. Cl. G06F 3/01; G02B 3/02; G02B 27/22

(52) U.S. Cl. CPC G06F 3/011; G02B 3/02; G03H 2001/0088; G02B 27/2242; G02B 27/2257

(57) ABSTRACT

An example apparatus for a beam guiding device. The apparatus includes a curved lens and a beam splitter attached to the curved lens for splitting an incident light beam into a number of light beams. The apparatus may also include a coupling holographic optical element (HOE) attached to the curved lens to divert the number of light beams to a holographic coupling angle. The apparatus may also include a pair of waveguide HOEs to reflect the number of light beams within the curved lens. The apparatus may also include a decoupling HOE to divert the number of light beams from a holographic coupling angle out of the curved lens.

### TECHNICAL FIELD

The present techniques relate generally to the guiding of beams of light for a wearable device. More specifically, the present techniques relate to multilayered beam guiding techniques for use in head worn wearable devices.

### BACKGROUND ART

Projected beams of light may be used to display virtual objects to a user. The display of virtual objects to a user can provide an augmented reality or virtual reality experience for the user. The projection of light beams to a user can include a component that is worn on the head covering the eyes similar to goggles or glasses. Additional components that can be used in propagation or display of virtual objects in an augmented or virtual reality can include mobile devices, wearable devices, or display devices, including those that may be held or attached in the line of sight of a user.

### BRIEF DESCRIPTION OF THE DRAWINGS

FIG. 1 is a diagram of an example of a wearable device to project an image into the eye of a user using a hologram optical element guiding system;

FIG. 2 is a diagram of an example of a wearable curved lens close up showing beam propagation between two hologram optical element waveguides on a curved lens;

FIG. 3 is a diagram of a top down view of a user viewing a virtual image from a curved lens wearable device;

FIG. 4 is a block diagram illustrating an example computing device for beam guiding;

FIG. 5 is a flow chart illustrating a method for beam guiding;

FIG. 6 is a block diagram showing computer readable media that stores code for a beam guiding device;

FIG. 7 is a schematic of a head mountable display system exploded to show internal components; and

FIG. 8 is a schematic diagram showing an example of data flow in the device for beam guiding.

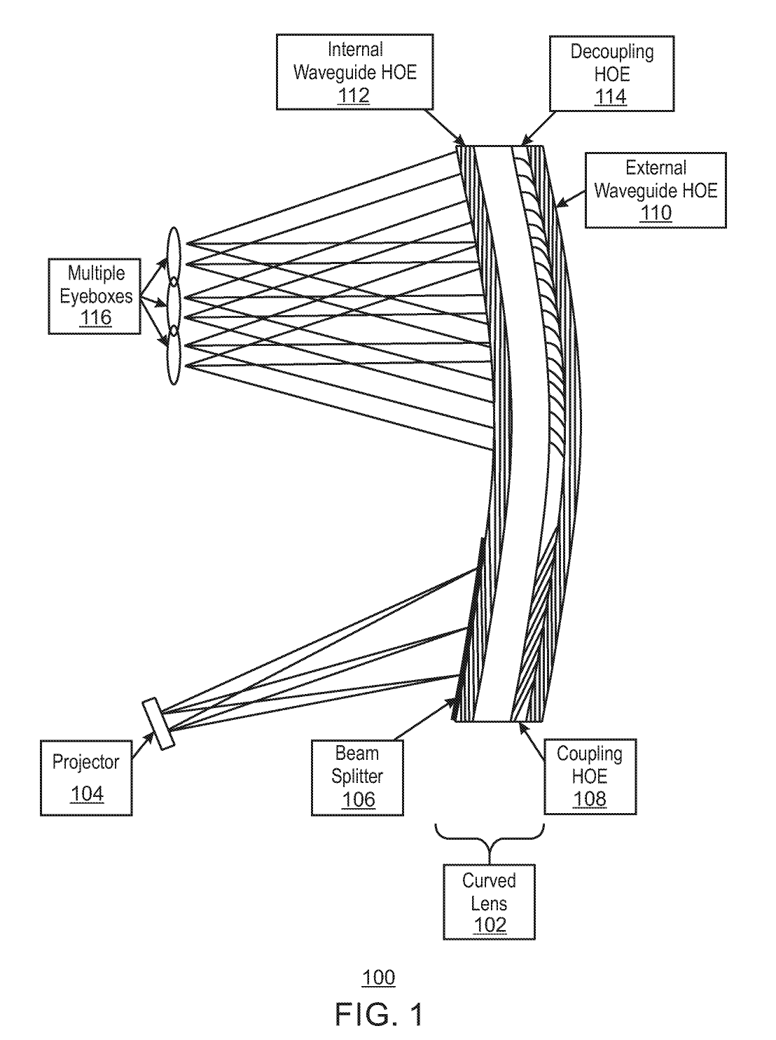

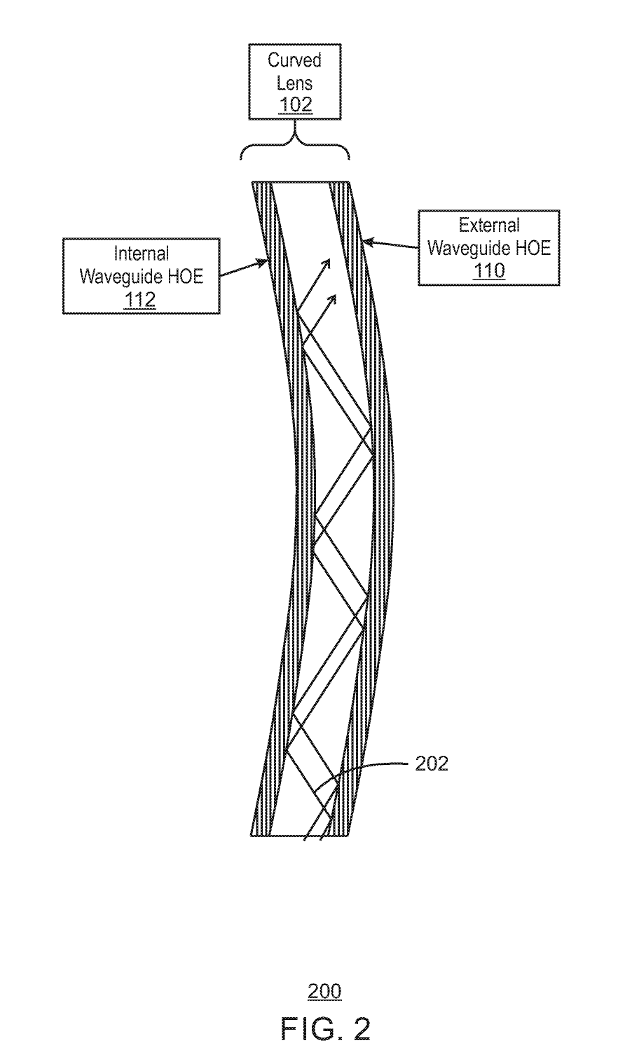

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Augmented reality (AR) and virtual reality (VR) glass and glass-like devices can be worn or held in a line of sight of a user in the form of glasses, goggles, visors, and the like. Throughout this document, references to augmented reality may also refer to techniques for virtual reality or a mix between AR and VR unless otherwise specified. Throughout this document, references to virtual reality may also refer to techniques for augmented reality or a mix between AR and VR unless otherwise specified. These devices can directly project light towards the eye of a user or can use a partially reflective or reflective medium to direct light towards the eye of the user. References in this document to medium that reflects light, guides light, and propagates light can refer to these and similar techniques and mediums used to control the path of beams of light and are interchangeable unless otherwise specified or distinguished through examples.

The field of view of a user can include anything the user can see in central and peripheral vision including unobstructed sight lines and images reflected, guided, or projected into the central and peripheral vision of the user. The action of guiding light and images towards a surface in the field of view of the user can include use of a light projector, a power source, or a processing resource such as a processor. A collection of these light projecting items can be referred to as an optical engine. An optical engine may be physically a part of the device or physically separate from the device.

When an image is projected from a projector, reflected, or otherwise guided into the eye of a user, the size of the display space that an image can visibly occupy can be called an eyebox and can have a size called an eyebox size. A user in an AR experience may see virtual objects in an eyebox spanning their entire field of view, or the eyebox may be smaller such that the eyebox covers a fraction of the field of view of the user. Virtual objects a user can view may include image properties familiar for objects shown on digital screen displays including resolution, brightness, color, and other visible features.

A device for AR may have bulk, weight, and shape considerations to enhance durability, unobtrusiveness, and ease of use. Accordingly, techniques to minimize the impact of adding the technology to available devices and wearable accessories may be a feature of the present techniques. For example, to improve a field of view for a user of AR, some devices physically enlarge a projector itself or add a number of projectors to the device so that an eyebox size of the user becomes enlarged to cover more of the field of view of the user. As the projector is enlarged or a number of projectors increases, so does the bulk and weight of the overall device. Similarly, as imaging becomes more complex and images become larger and more detailed in resolution, additional projectors and power may be included, but may result in an increase in weight of the device and altering the device to accommodate the additional bulk. Reflection techniques may include features or a number of flat components to guide beams for reflection rather than through use of curved reflection and light guiding surfaces.

Use of flat lens features results in a device that is not similar to the typical curved appearance of eyeglasses. While in some products flat components may be merged or combined with curved components, the use of both flat and curved surfaces increase the bulk, weight, complexity and may reduce the durability of the final product. Further, systems that use bulky combining prisms, flat waveguides, or substitute lenses with panel displays can be large and cumbersome, have flat lenses, and may blind the user to part or all of a field of view. For a customary eyewear look, the glass of the eyewear curves and there are few, if any, attached parts. The presently disclosed techniques enable a large eyebox size, full color spectrum of the virtual images, curved glass, a large field of view, and an optical engine less obtrusive than others providing similar results. In an example, the optical engine may work with a micro-electro-mechanical systems (MEMS) scanning mirror, a microscanner, a laser scanner, spatial light modulators, or a micro-opto-electromechanical system.

In an example, a projector can include a light source, a collimation lens, a 2-axis scanning mirror and a projection lens. In this example, the light source or sources may be a vertical-cavity surface-emitting laser (VCSEL), edge emitting lasers, micro LED, resonant cavity LED, or quantum dot laser. While the wavelength projected may be monochromatic, the wavelengths projected may also be red, green and blue (RGB). A collimation lens is used to make a collimated beam out of the light source. A scanning mirror can scan two axes or more to be able to project a 2D image. A projection lens is used to project the virtual image at the virtual image plane and to correct optical aberrations such as astigmatism, coma, and keystone. In an example, the image projector is a MEMS-based scanning mirror and RGB light sources that projects an image towards the AR lens.

In the present disclosure, a transparent lens (for example, a transparent AR lens) can be made of glass or a glass like substance that incorporates a multilayered holographic lightguide and combining optics. The combining optics are recorded in several transparent holographic optical elements (HOE). In an example, HOE can be a hologram on a film and the film may be affixed to a lens. The HOEs are used to create multiple eyeboxes, couple the light into the lightguide, guide the light, decouple the light from lightguide, and create an imaging pupil. The multiple eyeboxes may be overlapped in position so that the resulting field of view for a user appears with what appears to be a larger eyebox from the combination of the multiple eyeboxes. The coupling of the light into the light guide with the HOEs allows the propagating medium to be curved. The light guide further allows incident beams of projected light to avoid optical power at the interface of the curved lens surface and the air. While total internal reflection (TIR) relies on the reflection of light at glass-air interfaces, the reflection off a hologram film may function without the use of total internal reflection. In particular, TIR relies on use of flat interfaces, while an HOE waveguide can curve. If a lens using TIR were not flat then flat TIR waveguide lenses introduce optical power at each reflection. In a system using TIR in a curved lens, the light travelling inside the TIR waveguide transforms by an optical power at each reflection. Light that is transformed by an optical power can be deformed beyond recognition without complex correction for each ray and beam of the system. For normal eyewear lenses with a toroidal shape, such as a toric lens, use of a curved TIR waveguide lens may include errors, where use of HOE waveguides can avoid this issue.

Further, the disclosed device can use a MEMS-based projector to generate the image on a HOE based guider. The guider allows a projector to project an increased eyebox size or multiple beams corresponding to overlapping eyeboxes without increasing the size of the projector or the corresponding optical engine. A diffraction grating in the system can generate the multiple eyeboxes from initially projected beams. Through the diffraction grating, projector beams can reach several stacked HOEs that form a waveguide to guide the beams from a light coupler, within the lens to a light decoupler, to form an image for a user.

In the following disclosure, numerous specific details are set forth, such as examples of specific types of processors and system configurations, specific hardware structures, specific instruction types, specific system components, etc. in order to provide a thorough understanding of the present disclosure. It can be apparent, however, to one skilled in the art that these specific details need not be employed to practice the presently disclosed techniques. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the presently disclosed techniques.

FIG. 1 is a diagram of an example of a wearable device 100 to project an image into the eye of a user using a HOE guider system. The curved lens 102 can be a see through (or transparent) lens and may be glass, polycarbonate, plastic, photochromic materials, polyurethane, or other materials with a polymer or monomer structure including urethane-based monomer structured material. An image for showing a virtual object, texture, text, or other visualization can be generated by a scanner for projection. In an example, the scanner may part of the projector 104 and may be a MEMS based scanner to avoid placing a non-transparent panel display close to the lenses. With a small scanner, the projecting of the image can be done with hardware and can be enclosed in a normal sized stem of a pair of glasses where the image is projected in the free space between the head of a user and the lenses to reach the beam splitter. The projector 104 is shown as a MEMS-based projector. The projector 104 size may be small compared to that of a panel display, and accordingly, the projector can fit inside eyewear stem. In an example, the projector may be a small scanning mirror and laser source.

In FIG. 1, the image projected by the projector 104 is focused on a beam splitter 106 that is attached or directly applied onto the curved lens 102. The beam splitter 106 can be a reflective or a transmissive diffractive optical element (DOE) or a HOE depending on the beam splitter location. For example, the beam splitter 106 could be applied to the curved lens 102 on the convex outer side and be a reflective beam splitter. In FIG. 1, the beam splitter 106 is placed on the inside concave side of the curved lens 102 and allows transmission through itself. As seen in the drawing of FIG. 1, the beam splitter 106 can be placed directly on the glass, away from the viewer's central vision, and the light can be guided inside the glass using a holographic waveguide. The beam splitter 106 splits the incoming beam into an array of beams propagating with different angles. In an example, the array of beams can be made in a number of patterns such as square array, rectangular array, hexagonal array having any sizes, 2×2, 3×3, 2×3, 2×10 beams, etc. Using the beam splitter can increase the outcome eyebox size. The outcome eyebox size is proportional to the beam splitter angular splitting and number of spots that are generated within the array and the size of the array.

The image projected by the projector 102 is split by the beam splitter 106 into multiple images propagating through the curved lens 102 with a slightly different angle from each other. When the beams propagate through curved lens 102 and the beam splitter 106, they will intersect with a coupling HOE 108. The coupling hologram is used to couple the split beams into the holographic waveguide. To couple in the holographic waveguide the coupled beams can be orientated with an angle that falls between the angular acceptance bandwidth of the holograms of the waveguide. The coupling HOE 108 is recorded and applied so that the design of the coupling HOE adjusts the direction of the light to direct the multiple images to an internal waveguide HOE 112 that is on the inside convex curve of the curved lens 102. The optical function of the coupling HOE 108 is the one of a tilted mirror. The hologram placed on the glass surface guides the light instead of the glass-air interface. The recording of the hologram allows the hologram to act like a flat mirror even if the hologram is placed on a curved geometrical shaped glass. For example, if a collimated beam is coupled into a curved holographic waveguide then it will remain collimated throughout propagation in the curved waveguide seeing no optical power. Moreover, compared to waveguides that are flat, the field of view (FOV) using a hologram film on a curved surface may not be limited by a total internal reflection angle limit. Flat waveguides relying on total internal reflection between the air-glass interface, may have reflection from the total internal reflection angle to 90° where reflection still occurs, and where the angle is measured from the normal to the surface. In an example, a beam incident normal to a surface has 0° angle of incidence and total internal reflection occurs between the total internal reflection angle, for example 60°, up to 90°. Unlike flat waveguides, use of a hologram film on a curved surface will not define the FOV of a user based on a total internal reflection range. Instead, use of holographic guides on a curved surface can be recorded to allow a FOV beyond what a total reflection angle may allow.

The external waveguide HOE 110 forms half of the light guide for the curved lens 102. As the light reflects from the reflective coupling hologram of the external waveguide HOE 110, it will travel through the curved lens 102 to intersect with the internal waveguide HOE 112. The internal waveguide HOE 112 is located on the concave curve of the curved lens 102. The light guide is formed by the two oppositely placed reflective holograms one as the external waveguide HOE 110 and the other as the internal waveguide HOE 112. The HOE is placed on a plastic lens allowing the system to be lighter than a full display projection may be.

The light bounces inside the two part holographic light guide until it reaches the output or decoupling HOE 114. This use of holographic waveguides in this system includes carefully choosing the angular selectivity of each hologram for each of the waveguides. As the light and images are decoupled from the waveguides, the light beams may exit the eyebox will share the same spot distribution as the one generated by the beam splitter. As used herein, spot distribution refers to a diffracted pattern generated by the beam splitter, where this pattern can be a square, rectangular, repeating hexagons and other shapes aligned in a 2×2, 3×2, or other arrangement. The beam splitter spot distributor gives the shape of the eyeboxes that match the pattern of the beam splitter shape and correspond in size and arrangement. The spot distribution and arrangement corresponds to the shape and size of the eyebox. The angle at which the split beams are reflected by the coupling HOE and the decoupling HOE can be opposite directions for the same angle, or may be other angles to direct the image towards the user. In an example the angle at which the split beams are reflected by the decoupling HOE are not within the angular selectivity of the waveguide. The specific angles and holograms may be printed to the coupling and decoupling HOEs applied through the recording process based on the angle of the curve, the bandwidth of beams to be sent, and by the recording properties of the HOE waveguides.

FIG. 2 is a diagram of an example of a wearable curved lens close up 200 showing beam propagation between two HOE waveguides on a curved lens 102. Like numbered items are as described in FIG. 1.

As discussed above, the paired HOE waveguides act similarly to two flat mirrors based on the hologram affixed to each. In an example, the affixing can be any attaching process including lamination for glass or plastic, casted or injected for a HOE film, or printed depending on the mediums involved. Recording of a hologram may occur using two or more coherent laser beams. By recording the hologram accordingly, the HOE waveguides may act like a flat mirror for incident light beams even if the HOE waveguide film is placed on a curved geometrical shaped glass. For example, if a collimated beam 202 is coupled in the curved HOE waveguides 110, 112 then the collimated beam 202 remains collimated throughout the propagation in the curved waveguide seeing no optical power. As used herein, optical power refers to a degree to which a lens converges or diverges light particularly at a lens-air interface. Avoiding optical power by reflection by the HOE element allows the beam to avoid the distortive and direction altering effects of the lens-air interface.

As shown here, the multiple HOEs are assembled together in a stack. In an example, the HOE can also be multiplexed in a single HOE layer to avoid having to stack the hologram films which increases complexity of the system. One working principle of the use of HOEs for reflection is based, on the optical efficiency optimization of each hologram. For example, each hologram film for use in a HOE waveguide can be optimized by recording parameters to be the most effective within a specific acceptance angular bandwidth. The coupling HOE may be optimized to reflect the rays incoming from a projector angle and to direct them at another specific angle range. The range a HOE reflects can then be within the larger range of angular acceptance bandwidth of a waveguide HOE rather than the smaller angle of acceptance required for TIR.

In FIGS. 1 and 2, at the overlapping regions of the coupling HOE and waveguide HOE a filtering of beams through angular selection of incident beams can be made. For example, if the angle of the incident beams to a coupling or decoupling HOE are within a first range, those incident beams may be reflected or transmitted by the hologram based on their angle of incidence to the hologram. In an example, the refractive indexes of the HOE material and the waveguide material may be close or identical to each other to avoid ghost reflections.

Using the HOE waveguides, light can be guided until the decoupling HOE is reached as shown in FIG. 1. The decoupling HOE 114 decouples the light from the two part waveguide and forms an exit pupil of the system for a user to view.

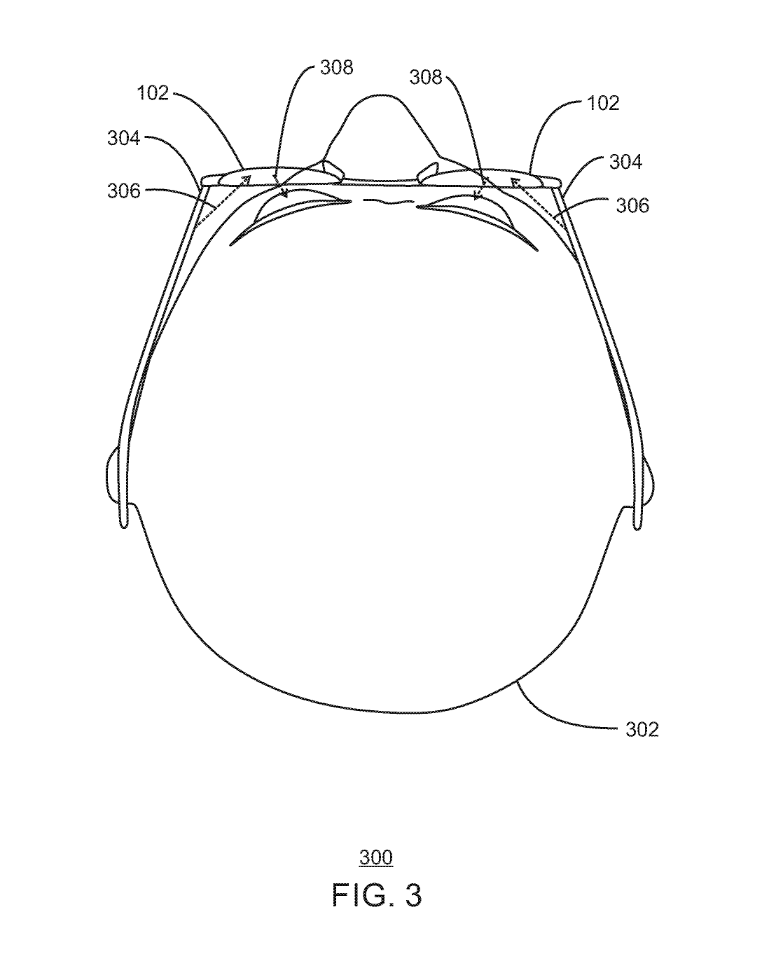

FIG. 3 is a diagram of a top down view of a user viewing a virtual image from a curved lens wearable device 300. Like numbered items are as described above.

The example provided by FIG. 3 is one example context for the presently disclosed techniques. For example, the user 302 may be wearing AR enabled glasses with the curved lenses 102. The glasses shown in FIG. 3 include glasses stems 304 that may contain and support a projector to project laser light or other light towards the curved lenses 102. The stems 304 of the pair of glasses may encase the projector with an opening for light to propagate. A projector in the stems 304 directs an initially projected beam 306 towards a beam splitter on the curved lenses 102 as discussed with respect to FIG. 1. Inside the curved lenses 102 the beam may be split, coupled, guided, and then decoupled from the waveguides to exit the curved lenses 102. The exiting beams 308 may form an eyebox or multiple eyeboxes for the user 302 to view.

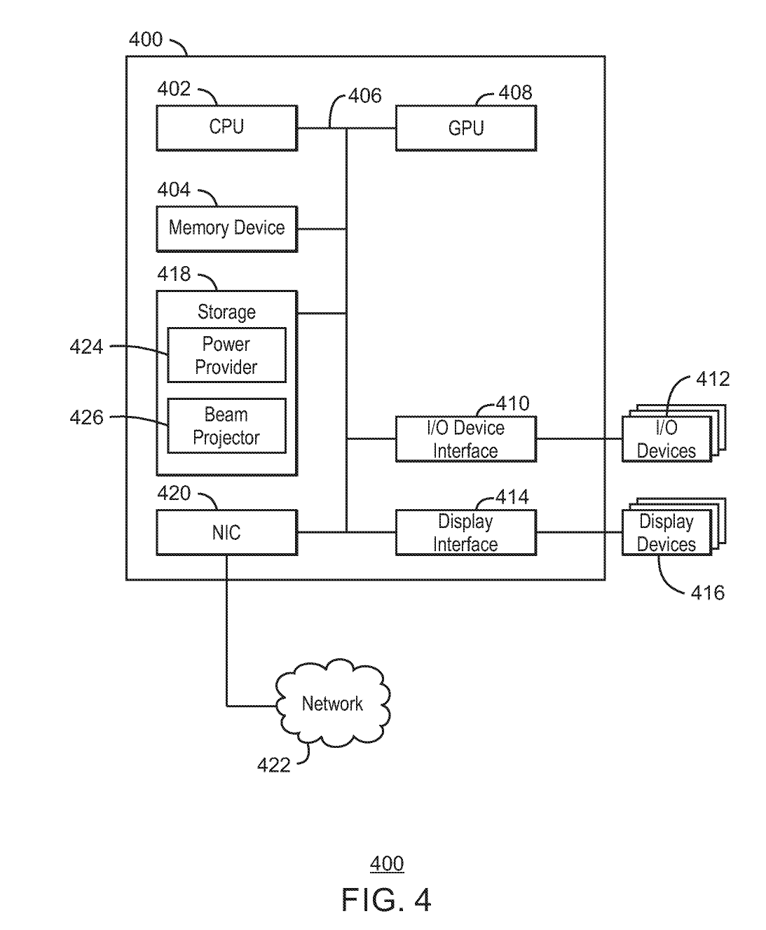

FIG. 4 is a block diagram illustrating an example computing device for beam guiding. The computing device 400 may be, for example, a laptop computer, desktop computer, tablet computer, mobile device, or server, among others. The computing device 400 may include a central processing unit (CPU) 402 that is configured to execute stored instructions, as well as a memory device 404 that stores instructions that are executable by the CPU 402. The CPU 402 may be coupled to the memory device 404 by a bus 406. Additionally, the CPU 402 can be a single core processor, a multi-core processor, a computing cluster, or any number of other configurations. Furthermore, the computing device 400 may include more than one CPU 402. The memory device 404 can include random access memory (RAM), read only memory (ROM), flash memory, or any other suitable memory systems. For example, the memory device 404 may include dynamic random access memory (DRAM).

The computing device 400 may also include a graphics processing unit (GPU) 408. As shown, the CPU 402 may be coupled through the bus 406 to the GPU 408. The GPU 408 may be configured to perform any number of graphics operations within the computing device 400. For example, the GPU 408 may be configured to render or manipulate graphics images, graphics frames, videos, or the like, to be displayed to a user of the computing device 400.

The memory device 404 can include random access memory (RAM), read only memory (ROM), flash memory, or any other suitable memory systems. For example, the memory device 404 may include dynamic random access memory (DRAM).

The CPU 402 may also be connected through the bus 406 to an input/output (I/O) device interface 410 configured to connect the computing device 400 to one or more I/O devices 412. The I/O devices 412 may include, for example, a keyboard and a pointing device, wherein the pointing device may include a touchpad or a touchscreen, among others. The I/O devices 412 may be built-in components of the computing device 400, or may be devices that are externally connected to the computing device 400. In some examples, the memory 404 may be communicatively coupled to I/O devices 412 through direct memory access (DMA). The I/O devices 412 may also be a camera for detecting displayed calibration-pattern images. The camera can be a camera detecting visible light, infrared light, or any combination of electromagnetic detectable signals.

The CPU 402 may also be linked through the bus 406 to a display interface 414 configured to connect the computing device 400 to a display device 416. The display device 416 may include a display screen that is a built-in component of the computing device 400. The display device 416 may also include a computer monitor, television, or projector, among others, that is internal to or externally connected to the computing device 400. The projector may display a stored calibration-pattern image to a projection surface.

The computing device also includes a storage device 418. The storage device 418 is a physical memory such as a hard drive, an optical drive, a thumbdrive, an array of drives, or any combinations thereof. The storage device 418 may also include remote storage drives.

The computing device 400 may also include a network interface controller (NIC) 420. The NIC 420 may be configured to connect the computing device 400 through the bus 406 to a network 422. The network 422 may be a wide area network (WAN), local area network (LAN), or the Internet, among others. In some examples, the device may communicate with other devices through a wireless technology. For example, the device may communicate with other devices via a wireless local area network connection. In some examples, the device may connect and communicate with other devices via Bluetooth® or similar technology.

A CPU 402 can execute instructions stored in the power provider 424 stored in storage 418 to instruct the providing of power to a projector comprising a scanning mirror and a light source. The CPU 402 can execute instructions stored in the beam projector to project an incident beam towards a curved lens. In an example, the CPU 402 can execute instructions stored in the beam projector to instruct a projected beam towards a beam splitter to be split into a plurality of light beams, where a coupling holographic optical element (HOE) attached to the curved lens diverts the plurality of light beams to a holographic coupling angle, a pair of waveguide HOEs reflect the plurality of light beams through the curved lens, and a decoupling HOE diverts the plurality of light beams from a holographic coupling angle out of the curved lens.

In an example of this system, the beam splitter is a diffractive optical element or a holographic optical element. The beam splitter may also be mounted on a convex side or the concave side of a curved lens. In an example of the system, the waveguide HOEs comprise a first HOE that is a flexible film attached to a convex side of the curved lens and a second HOE that is a flexible film attached to a concave side of the curved lens. In an example, the decoupling HOE may divert the plurality of light beams out of the curved lens to form multiple eyeboxes. In an example, the curved lens is made of a material with a corresponding maximum total internal reflection angle, and wherein the holographic coupling angle is smaller than the internal reflection angle. The curved lens is a toric lens shape. In an example, an incident light beam is a laser projected from a stem of a glasses frame, where the glasses frame is securing the curved lens.

The block diagram of FIG. 4 is not intended to indicate that the computing device 400 is to include all of the components shown in FIG. 4. Rather, the computing device 400 can include fewer or additional components not illustrated in FIG. 4, such as additional USB devices, additional guest devices, and the like. The computing device 400 may include any number of additional components not shown in FIG. 4, depending on the details of the specific implementation. Furthermore, any of the functionalities of the CPU 402 may be partially, or entirely, implemented in hardware and/or in a processor.

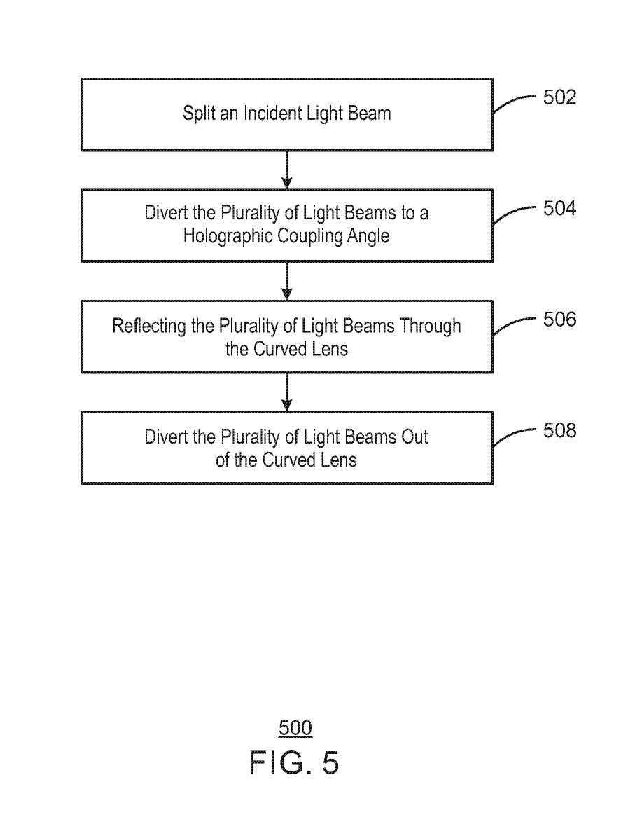

FIG. 5 is a flow chart illustrating a method for beam guiding. The example method is generally referred to by the reference number 500 and can be implemented using the system 400 of FIG. 5 above.

At block 502, the method includes splitting an incident light beam into a plurality of light beams with a beam splitter attached to a curved lens. In an example, the beam splitter may be a diffractive optical element or a holographic optical element. In an example, the beam splitter may be mounted on a convex side of a curved lens or a concave side of a curved lens. In an example, the curved lens is made of a material with a corresponding maximum total internal reflection angle. The holographic coupling angle may be smaller than the internal reflection angle. In an example, the curved lens may be the shape of a toric lens. In an example, the incident light beam may be a laser projected from a stem of a glasses frame, where the glasses frame is securing the curved lens.

At block 504, the method includes diverting, with a coupling holographic optical element (HOE) attached to the curved lens, the plurality of light beams to a holographic coupling angle. At block 506, the method includes reflecting, with a pair of waveguide HOEs, the plurality of light beams at a holographic coupling angle through the curved lens. In an example, the waveguide HOEs includes a first HOE that may be a flexible film attached to a convex side of the curved lens and a second HOE that is a flexible film attached to a concave side of the curved lens.

At block 508, the method includes diverting, with a decoupling HOE, the plurality of light beams from a holographic coupling angle out of the curved lens. In an example, the decoupling HOE diverts the plurality of light beams out of the curved lens to form multiple eyeboxes.

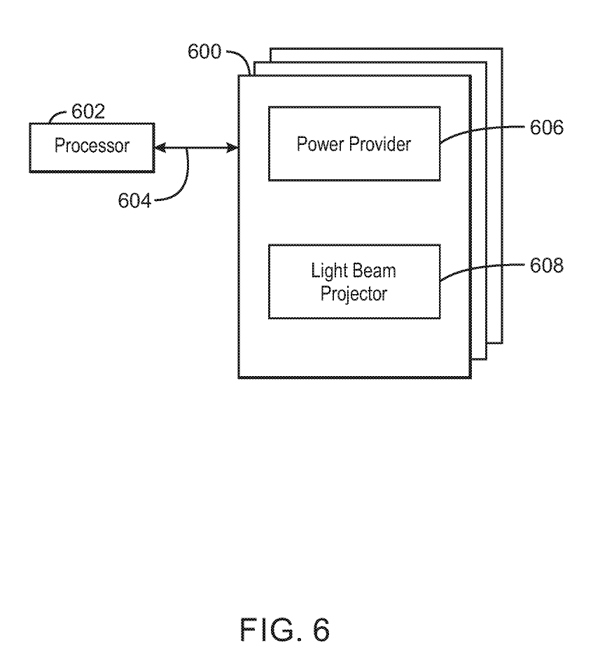

FIG. 6 is a block diagram showing computer readable media that stores code for a beam guiding device. The computer readable media 600 may be accessed by a processor 602 over a computer bus 604. Furthermore, the computer readable medium 600 may include code configured to direct the processor 602 to perform the methods described herein. In some embodiments, the computer readable media 600 may be non-transitory computer readable media. In some examples, the computer readable media 600 may be storage media. However, in any case, the computer readable media do not include transitory media such as carrier waves, signals, and the like.

The block diagram of FIG. 6 is not intended to indicate that the computer readable media 600 is to include all of the components shown in FIG. 6. Further, the computer readable media 600 may include any number of additional components not shown in FIG. 6, depending on the details of the specific implementation.

The various software components discussed herein may be stored on one or more computer readable media 600, as indicated in FIG. 6. For example, a power provider 606 can instruct the providing of power to a projector comprising a scanning mirror and a light source. The processor 602 can execute instructions stored in the light beam projector 608 to project an incident beam towards a curved lens. In an example, the processor 602 can execute instructions stored in the beam projector to instruct a projected beam towards a beam splitter to be split into a plurality of light beams, where a coupling holographic optical element (HOE) attached to the curved lens diverts the plurality of light beams to a holographic coupling angle, a pair of waveguide HOEs reflect the plurality of light beams through the curved lens, and a decoupling HOE diverts the plurality of light beams from a holographic coupling angle out of the curved lens.

In an example of this computer readable media 600, the beam splitter may be a diffractive optical element or a holographic optical element. The beam splitter may also be mounted on a convex side or the concave side of a curved lens. In an example of this computer readable media 600, the waveguide HOEs comprise a first HOE that is a flexible film attached to a convex side of the curved lens and a second HOE that is a flexible film attached to a concave side of the curved lens. In an example of this this computer readable media 600 system, the decoupling HOE may divert the plurality of light beams out of the curved lens to form multiple eyeboxes. The curved lens may be made of a material with a corresponding maximum total internal reflection angle, and wherein the holographic coupling angle is smaller than the internal reflection angle. The curved lens may also be a toric lens shape. In an example of this this computer readable media 600 system, an incident light beam is a laser projected from a stem of a glasses frame, where the glasses frame is securing the curved lens.

The block diagram of FIG. 6 is not intended to indicate that the computer readable media 600 is to include all of the components shown in FIG. 6. Further, the computer readable media 600 may include any number of additional components not shown in FIG. 6, depending on the details of the specific implementation.

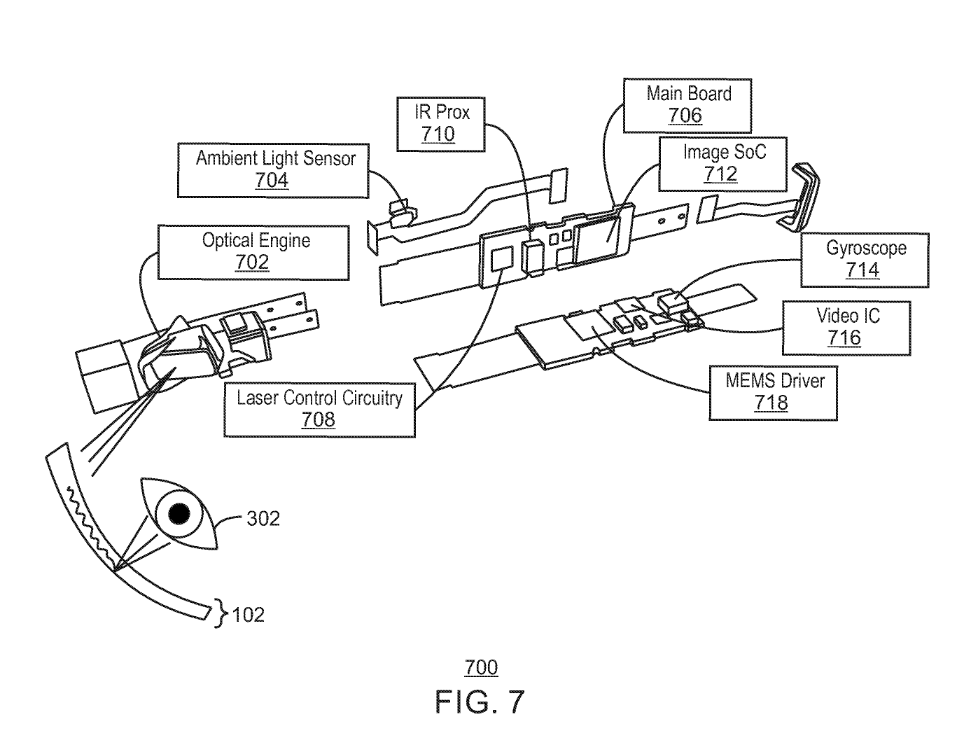

FIG. 7 is a schematic of a head mountable display system 700 exploded to show internal components. Like numbered items are as described with respect to FIG. 1 and FIG. 3.

When installed and activated the components of the head mountable display system may be assembled as a single piece of hardware to be worn on the head and to generate beams of light to be guided by the wearable curved lens 102. In an example, the head mountable display system 700 may be implemented in frame 304 of FIG. 3 as part of an AR glasses system.

An optical engine 702 may be used to generate and direct a beam of light towards a curved lens 102 for guiding. The light generation may be through a laser generator or another form of lights projected. The light generated can be directed in the intended direction using an actuated mirror to guide the light. The head mountable display system 700 can include an ambient light sensor 704 to sense the brightness of light an environment includes. Based on the light detected from the ambient light sensor 704, an optical engine 702 can adjust the output light being projected. In an example, if the ambient light is detected by the ambient light sensor 704 as brighter than a previous environment, the optical engine 702 may increase the intensity of the light being projected towards the curved glass for viewing by a user.

The head mountable display system 700 can include a main board 706 to hold components, circuits, detection instruments, and other processing and storage resources as part of the head mountable system 700. In an example, the main board can be a printed circuit board made of glass fiber reinforced epoxy resin with copper foil bonded on one or both sides. For example, a laser control circuitry 708 can be located on the main board 706, to drive the impulses of a laser light in the optical engine 702. In an example, the laser control circuitry can be a current source to deliver electrical current to a laser diode in the optical engine 702 for the laser diode to generate laser light.

The main board 706 can also include an IR proximity device 710 to detects whether the user is wearing the glasses, if the sensor detects that the user is not wearing the glasses then it powers the system down to save battery power. The IR proximity device may be for infrared (IR) light or other types of proximity detecting sensors and light can also be used.

The main board 706 can also include an image system on a chip (SoC) 712. The image SoC 706 can be used as a processing and storage location for images to be displayed to the user. Based on an image to be projected, the image SoC 714 can direct the laser control circuitry 708 to vary current to the laser diodes of the optical engine 702. In an example, the laser control circuitry 708 can be an analog application-specific integrated circuit (ASIC).

As discussed above, the main board 706 can hold components on more than one side. Accordingly, the head mountable display system 700 shows a backside of the main board 706 in FIG. 7. The main board 706 can hold a gyroscope 714 to aid in identifying movement and position of the head mountable display system 700. In an example, the gyroscope can be a three-axis gyroscope, a six-axis gyroscope, or another sensor that determine movement and orientation of the head mountable display system 700. The main board 706 can include a Video integrated circuit (IC) to generate video signal for sending to the optical engine 702 for display. This video generation can include generating the timing of video signals such as the horizontal and vertical synchronization signals and the blanking interval signal. The main board 706 can include a micro-electro-mechanical systems (MEMS) driver 718 to provide and adjust current sent to a mirror in the optical engine 702. In an example, the MEMS driver 718 can be considered laser control circuitry 708 and may be an ASIC. Based on the modulation of current in the MEMS driver 718, the mirror can change position in order to direct the light towards a curved lens 102 in order to be visible to a user. The head mountable display system 700 includes a curved lens 102 where the light from the optical engine 702 can project light, be guided by the HOE film layers and exit to form an eyebox at the eye of a user 302.

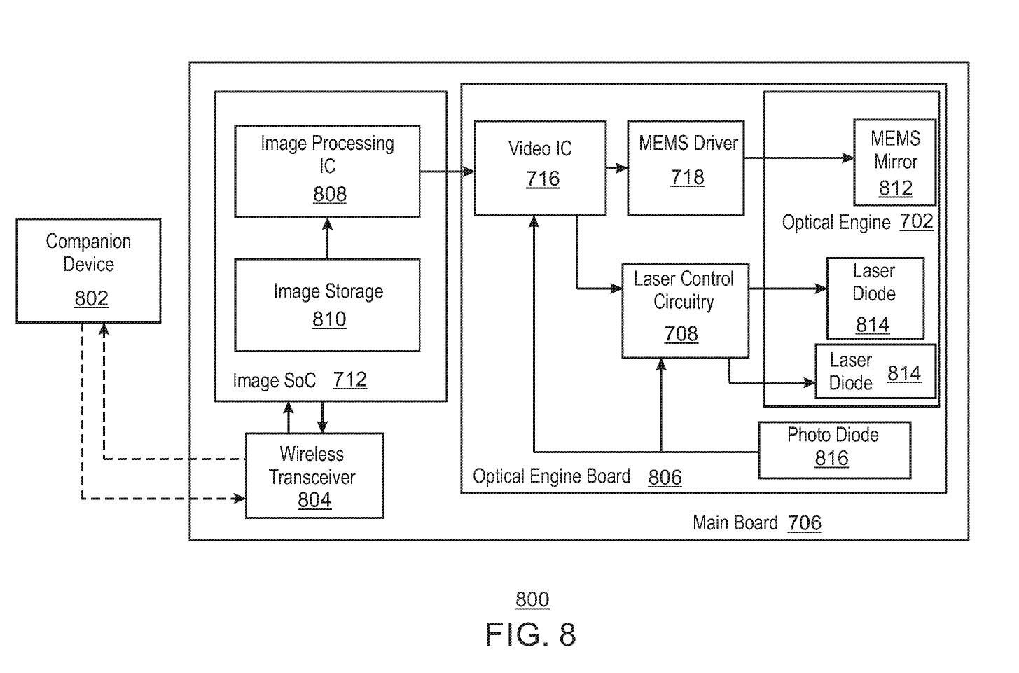

FIG. 8 is a schematic diagram showing an example of device data flow 800 for beam guiding. Like numbered items are as they are described with respect to FIG. 7. The illustrated device data flow 800 may be implemented in frame 304 of FIG. 3 as part of an AR glasses system.

A companion device 802 can wirelessly connect and communicate to components on the main board 706 through a wireless transceiver 804. In an example, the companion device can be a phone, tablet, laptop, desktop, or other computing device capable of wireless communication. The wireless transceiver 804 can use a number of commination methods including cellular communication, a Wi-Fi connection, Bluetooth, or other communication means. In an example, the companion device 802 may provide images, video, or data used to direct an optical engine 702 what to project toward a curved glass beam guider.

This data may travel from the wireless transceiver 804 to an image SoC 712 on its way to an optical engine board 806. The optical engine board 806 can hold components used for directing the optical engine 702. In an example, the imaged SoC 712 can include an image processing IC 808 and image storage 810. Data stored on the image storage 810 can be persistent from a previously generated image for display or can be new image data received from the wireless transceiver 804. The image processing IC 808 can take data received from the wireless transceiver and stored in the image storage 810 and provide this data to the optical engine board 806 through the video IC 716.

The Video IC 716 can direct the MEMS driver 718 and the laser control circuitry 708. The laser control circuitry 708 can provide and modify current provided to a MEMS mirror 812 located in the optical engine 702. Similarly, the laser control circuitry 708 can provide and modify current provided to laser a laser diode 814 or several laser diodes located in the optical engine 702.

The optical board can also hold a photodiode 816 that can provide feedback to the laser control circuitry 708 or the video IC 716 to allow these components to adjust their output. The photodiode 816 can be a semiconductor device to convert detected light into current and can used this feature as a sensor of light that has been output by the head mountable display system 700. In an example, the photodiode 816 can be implemented as an ambient light sensor 704. In an example, the photodiode 816 can be used to measure light output generated by a laser diode 814 projecting light toward the curved lens.

The above is provided as a guideline and example of the device data flow 800 and the head wearable display system 700. These components can work together to direct a laser and MEMS module. Additional integrated circuits may be associated with controlling the laser and MEMs modules, depending on the details of the specific implementation.

### EXAMPLES

### Example 1

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a curved lens apparatus for a beam guiding device including: a curved lens, a beam splitter attached to the curved lens for splitting an incident light beam into a plurality of light beams, a coupling holographic optical element (HOE) attached to the curved lens to divert the plurality of light beams to a holographic coupling angle, a pair of waveguide HOEs to reflect the plurality of light beams within the curved lens, and a decoupling HOE to divert the plurality of light beams from a holographic coupling angle out of the curved lens. Other embodiments of this aspect include corresponding computer systems, apparatus, and computer programs recorded on one or more computer storage devices, each configured to perform the actions of the methods.

Implementations may include one or more of the following features. The apparatus where the beam splitter is a diffractive optical element. The apparatus where the beam splitter is a holographic optical element. The apparatus where the beam splitter is mounted on a convex side of a curved lens. The apparatus where the beam splitter is mounted on a concave side of a curved lens. The apparatus where the waveguide HOEs include a first HOE that is attached to a convex side of the curved lens and a second HOE that is attached to a concave side of the curved lens. The apparatus where the decoupling HOE diverts the plurality of light beams out of the curved lens to form multiple eyeboxes. The apparatus where the curved lens is made of a material with a corresponding maximum total internal reflection angle, and where the holographic coupling angle is smaller than the internal reflection angle. The apparatus where the curved lens is a toric lens shape. The apparatus where incident light beam is a laser projected from a stem of a glasses frame, where the glasses frame is securing the curved lens. The method where the beam splitter is a diffractive optical element. The method where the beam splitter is a holographic optical element. The method where the beam splitter is mounted on a convex side of a curved lens. The method where the beam splitter is mounted on a concave side of a curved lens. The method where the waveguide HOEs include a first HOE that is attached to a convex side of the curved lens and a second HOE that is attached to a concave side of the curved lens. The method where the decoupling HOE diverts the plurality of light beams out of the curved lens to form multiple eyeboxes. The method where the curved lens is made of a material with a corresponding maximum total internal reflection angle, and where the holographic coupling angle is smaller than the internal reflection angle. The method where the curved lens is toric lens shaped. The method where incident light beam is a laser projected from a stem of a glasses frame, where the glasses frame is securing the curved lens. The computer-readable medium where the beam splitter is a diffractive optical element. The computer-readable medium where the beam splitter is a holographic optical element. The computer-readable medium where the beam splitter is mounted on a convex side of a curved lens. The computer-readable medium where the beam splitter is mounted on a concave side of a curved lens. The computer-readable medium where the waveguide HOEs include a first HOE that is attached to a convex side of the curved lens and a second HOE that is attached to a concave side of the curved lens. The computer-readable medium where the decoupling HOE diverts the plurality of light beams out of the curved lens to form multiple eyeboxes. The computer-readable medium where the curved lens is made of a material with a corresponding maximum total internal reflection angle, and where the holographic coupling angle is smaller than the internal reflection angle. The computer-readable medium where the curved lens is toric lens shaped. The computer-readable medium where incident light beam is a laser projected from a stem of a glasses frame, where the glasses frame is securing the curved lens. The system where the beam splitter is a diffractive optical element. The system where the beam splitter is a holographic optical element. The system where the beam splitter is mounted on a convex side of a curved lens. The system where the beam splitter is mounted on a concave side of a curved lens. The system where the waveguide HOEs include a first HOE that is attached to a convex side of the curved lens and a second HOE that is attached to a concave side of the curved lens. The system where the decoupling HOE diverts the plurality of light beams out of the curved lens to form multiple eyeboxes. The system where the curved lens is made of a material with a corresponding maximum total internal reflection angle, and where the holographic coupling angle is smaller than the internal reflection angle. The system where the curved lens is a toric lens shape. The system where incident light beam is a laser projected from a stem of a glasses frame, where the glasses frame is securing the curved lens. The apparatus where the means for splitting beams is a diffractive optical element. The apparatus where the means for splitting beams is a holographic optical element. The apparatus where the means for splitting beams is mounted on a convex side of a curved lens. The apparatus where the means for splitting beams is mounted on a concave side of a curved lens. The apparatus where the waveguiding means include a first HOE that is attached to a convex side of the curved lens and a second HOE that is attached to a concave side of the curved lens. The apparatus where the means for decoupling diverts the plurality of light beams out of the curved lens to form multiple eyeboxes. The apparatus where the curved lens is made of a material with a corresponding maximum total internal reflection angle, and where the holographic coupling angle is smaller than the internal reflection angle. The apparatus where the curved lens is a toric lens shape. The apparatus where incident light beam is a laser projected from a stem of a glasses frame, where the glasses frame is securing the curved lens. Implementations of the described techniques may include hardware, a method or process, or computer software on a computer-accessible medium.

### Example 2

One general aspect includes a method for combining beams in a curved lens including: splitting an incident light beam into a plurality of light beams with a beam splitter attached to a curved lens; diverting, with a coupling holographic optical element (HOE) attached to the curved lens, the plurality of light beams to a holographic coupling angle; reflecting, with a pair of waveguide HOEs, the plurality of light beams at a holographic coupling angle within the curved lens; and diverting, with a decoupling HOE, the plurality of light beams from a holographic coupling angle out of the curved lens. Other embodiments of this aspect include corresponding computer systems, apparatus, and computer programs recorded on one or more computer storage devices, each configured to perform the actions of the methods.

Implementations may include one or more of the following features. The method where the beam splitter is a diffractive optical element. The method where the beam splitter is a holographic optical element. The method where the beam splitter is mounted on a convex side of a curved lens. The method where the beam splitter is mounted on a concave side of a curved lens. The method where the waveguide HOEs include a first HOE that is attached to a convex side of the curved lens and a second HOE that is attached to a concave side of the curved lens. The method where the decoupling HOE diverts the plurality of light beams out of the curved lens to form multiple eyeboxes. The method where the curved lens is made of a material with a corresponding maximum total internal reflection angle, and where the holographic coupling angle is smaller than the internal reflection angle. The method where the curved lens is toric lens shaped. The method where incident light beam is a laser projected from a stem of a glasses frame, where the glasses frame is securing the curved lens. The computer-readable medium where the beam splitter is a diffractive optical element. The computer-readable medium where the beam splitter is a holographic optical element. The computer-readable medium where the beam splitter is mounted on a convex side of a curved lens. The computer-readable medium where the beam splitter is mounted on a concave side of a curved lens. The computer-readable medium where the waveguide HOEs include a first HOE that is attached to a convex side of the curved lens and a second HOE that is attached to a concave side of the curved lens. The computer-readable medium where the decoupling HOE diverts the plurality of light beams out of the curved lens to form multiple eyeboxes. The computer-readable medium where the curved lens is made of a material with a corresponding maximum total internal reflection angle, and where the holographic coupling angle is smaller than the internal reflection angle. The computer-readable medium where the curved lens is toric lens shaped. The computer-readable medium where incident light beam is a laser projected from a stem of a glasses frame, where the glasses frame is securing the curved lens. The system where the beam splitter is a diffractive optical element. The system where the beam splitter is a holographic optical element. The system where the beam splitter is mounted on a convex side of a curved lens. The system where the beam splitter is mounted on a concave side of a curved lens. The system where the waveguide HOEs include a first HOE that is attached to a convex side of the curved lens and a second HOE that is attached to a concave side of the curved lens. The system where the decoupling HOE diverts the plurality of light beams out of the curved lens to form multiple eyeboxes. The system where the curved lens is made of a material with a corresponding maximum total internal reflection angle, and where the holographic coupling angle is smaller than the internal reflection angle. The system where the curved lens is a toric lens shape. The system where incident light beam is a laser projected from a stem of a glasses frame, where the glasses frame is securing the curved lens. The apparatus where the means for splitting beams is a diffractive optical element. The apparatus where the means for splitting beams is a holographic optical element. The apparatus where the means for splitting beams is mounted on a convex side of a curved lens. The apparatus where the means for splitting beams is mounted on a concave side of a curved lens. The apparatus where the waveguiding means include a first HOE that is attached to a convex side of the curved lens and a second HOE that is attached to a concave side of the curved lens. The apparatus where the means for decoupling diverts the plurality of light beams out of the curved lens to form multiple eyeboxes. The apparatus where the curved lens is made of a material with a corresponding maximum total internal reflection angle, and where the holographic coupling angle is smaller than the internal reflection angle. The apparatus where the curved lens is a toric lens shape. The apparatus where incident light beam is a laser projected from a stem of a glasses frame, where the glasses frame is securing the curved lens. Implementations of the described techniques may include hardware, a method or process, or computer software on a computer-accessible medium.

### Example 3

One general aspect includes a tangible, non-transitory, computer-readable medium including instructions that, when executed by a processor, direct the processor to: provide power to a projector including a scanning mirror and a light source; and project an incident beam towards a curved lens. The tangible also includes a beam splitter to split an incident light beam into a plurality of light beams. The tangible also includes a coupling holographic optical element (HOE) attached to the curved lens to divert the plurality of light beams to a holographic coupling angle. The tangible also includes a pair of waveguide HOEs to reflect the plurality of light beams within the curved lens. The tangible also includes a decoupling HOE to divert the plurality of light beams from a holographic coupling angle out of the curved lens. Other embodiments of this aspect include corresponding computer systems, apparatus, and computer programs recorded on one or more computer storage devices, each configured to perform the actions of the methods.

Implementations may include one or more of the following features. The computer-readable medium where the beam splitter is a diffractive optical element. The computer-readable medium where the beam splitter is a holographic optical element. The computer-readable medium where the beam splitter is mounted on a convex side of a curved lens. The computer-readable medium where the beam splitter is mounted on a concave side of a curved lens. The computer-readable medium where the waveguide HOEs include a first HOE that is attached to a convex side of the curved lens and a second HOE that is attached to a concave side of the curved lens. The computer-readable medium where the decoupling HOE diverts the plurality of light beams out of the curved lens to form multiple eyeboxes. The computer-readable medium where the curved lens is made of a material with a corresponding maximum total internal reflection angle, and where the holographic coupling angle is smaller than the internal reflection angle. The computer-readable medium where the curved lens is toric lens shaped. The computer-readable medium where incident light beam is a laser projected from a stem of a glasses frame, where the glasses frame is securing the curved lens. The system where the beam splitter is a diffractive optical element. The system where the beam splitter is a holographic optical element. The system where the beam splitter is mounted on a convex side of a curved lens. The system where the beam splitter is mounted on a concave side of a curved lens. The system where the waveguide HOEs include a first HOE that is attached to a convex side of the curved lens and a second HOE that is attached to a concave side of the curved lens. The system where the decoupling HOE diverts the plurality of light beams out of the curved lens to form multiple eyeboxes. The system where the curved lens is made of a material with a corresponding maximum total internal reflection angle, and where the holographic coupling angle is smaller than the internal reflection angle. The system where the curved lens is a toric lens shape. The system where incident light beam is a laser projected from a stem of a glasses frame, where the glasses frame is securing the curved lens. The apparatus where the means for splitting beams is a diffractive optical element. The apparatus where the means for splitting beams is a holographic optical element. The apparatus where the means for splitting beams is mounted on a convex side of a curved lens. The apparatus where the means for splitting beams is mounted on a concave side of a curved lens. The apparatus where the waveguiding means include a first HOE that is attached to a convex side of the curved lens and a second HOE that is attached to a concave side of the curved lens. The apparatus where the means for decoupling diverts the plurality of light beams out of the curved lens to form multiple eyeboxes. The apparatus where the curved lens is made of a material with a corresponding maximum total internal reflection angle, and where the holographic coupling angle is smaller than the internal reflection angle. The apparatus where the curved lens is a toric lens shape. The apparatus where incident light beam is a laser projected from a stem of a glasses frame, where the glasses frame is securing the curved lens. Implementations of the described techniques may include hardware, a method or process, or computer software on a computer-accessible medium.

### Example 4

One general aspect includes a system for a beam guiding device including: a curved lens, a beam splitter attached to the curved lens for splitting an incident light beam into a plurality of light beams, a coupling holographic optical element (HOE) attached to the curved lens to divert the plurality of light beams to a holographic coupling angle, a pair of waveguide HOEs to reflect the plurality of light beams within the curved lens, and a decoupling HOE to divert the plurality of light beams from a holographic coupling angle out of the curved lens. Other embodiments of this aspect include corresponding computer systems, apparatus, and computer programs recorded on one or more computer storage devices, each configured to perform the actions of the methods.

Implementations may include one or more of the following features. The system where the beam splitter is a diffractive optical element. The system where the beam splitter is a holographic optical element. The system where the beam splitter is mounted on a convex side of a curved lens. The system where the beam splitter is mounted on a concave side of a curved lens. The system where the waveguide HOEs include a first HOE that is attached to a convex side of the curved lens and a second HOE that is attached to a concave side of the curved lens. The system where the decoupling HOE diverts the plurality of light beams out of the curved lens to form multiple eyeboxes. The system where the curved lens is made of a material with a corresponding maximum total internal reflection angle, and where the holographic coupling angle is smaller than the internal reflection angle. The system where the curved lens is a toric lens shape. The system where incident light beam is a laser projected from a stem of a glasses frame, where the glasses frame is securing the curved lens. The apparatus where the means for splitting beams is a diffractive optical element. The apparatus where the means for splitting beams is a holographic optical element. The apparatus where the means for splitting beams is mounted on a convex side of a curved lens. The apparatus where the means for splitting beams is mounted on a concave side of a curved lens. The apparatus where the waveguiding means include a first HOE that is attached to a convex side of the curved lens and a second HOE that is attached to a concave side of the curved lens. The apparatus where the means for decoupling diverts the plurality of light beams out of the curved lens to form multiple eyeboxes. The apparatus where the curved lens is made of a material with a corresponding maximum total internal reflection angle, and where the holographic coupling angle is smaller than the internal reflection angle. The apparatus where the curved lens is a toric lens shape. The apparatus where incident light beam is a laser projected from a stem of a glasses frame, where the glasses frame is securing the curved lens. Implementations of the described techniques may include hardware, a method or process, or computer software on a computer-accessible medium.

### Example 5

One general aspect includes a curved lens apparatus for a beam guiding device including: a curved lens, a means for splitting beams attached to the curved lens for splitting an incident light beam into a plurality of light beams, a holographic optical element (HOE) coupling means attached to the curved lens to divert the plurality of light beams to a holographic coupling angle, a pair of waveguiding means reflect the plurality of light beams within the curved lens, and a means for decoupling to divert the plurality of light beams from a holographic coupling angle out of the curved lens. Other embodiments of this aspect include corresponding computer systems, apparatus, and computer programs recorded on one or more computer storage devices, each configured to perform the actions of the methods.

Implementations may include one or more of the following features. The apparatus where the means for splitting beams is a diffractive optical element. The apparatus where the means for splitting beams is a holographic optical element. The apparatus where the means for splitting beams is mounted on a convex side of a curved lens. The apparatus where the means for splitting beams is mounted on a concave side of a curved lens. The apparatus where the waveguiding means include a first HOE that is attached to a convex side of the curved lens and a second HOE that is attached to a concave side of the curved lens. The apparatus where the means for decoupling diverts the plurality of light beams out of the curved lens to form multiple eyeboxes. The apparatus where the curved lens is made of a material with a corresponding maximum total internal reflection angle, and where the holographic coupling angle is smaller than the internal reflection angle. The apparatus where the curved lens is a toric lens shape. The apparatus where incident light beam is a laser projected from a stem of a glasses frame, where the glasses frame is securing the curved lens. Implementations of the described techniques may include hardware, a method or process, or computer software on a computer-accessible medium.

### Example 6

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a head mountable display system for guiding beams of light, including: a frame. The head mountable display system also includes an image processing integrated circuit mounted in the frame. The head mountable display system also includes an optical engine mounted in the frame; and a curved lens mounted in the frame, the curved lens. The head mountable display system also includes a beam splitter attached to the curved lens for splitting a light beam from the optical engine into a plurality of light beams. The head mountable display system also includes a coupling holographic optical element (hoe) attached to the curved lens to divert the plurality of light beams to a holographic coupling angle. The head mountable display system also includes a pair of waveguide hoes to reflect the plurality of light beams within the curved lens. The head mountable display system also includes a decoupling hoe to divert the plurality of light beams from a holographic coupling angle out of the curved lens. Other embodiments of this aspect include corresponding computer systems, apparatus, and computer programs recorded on one or more computer storage devices, each configured to perform the actions of the methods.

Implementations may include one or more of the following features. The system where the waveguide hoes include a first hoe that is attached to a convex side of the curved lens and a second hoe that is attached to a concave side of the curved lens. The system where the decoupling hoe diverts the plurality of light beams out of the curved lens to form multiple eyeboxes. The system where the curved lens is made of a material with a corresponding maximum total internal reflection angle, and where the holographic coupling angle is smaller than the internal reflection angle. The system where the optical engine includes: a laser diode to generate a light beam; and a micro-electro-mechanical system (mems) mirror to direct the light beam towards the curved lens. The system including a wireless transceiver to provide data to the image processing integrated circuit for display by the head mountable display device. The system including a wireless computing device to couple to the wireless transceiver to transmit image data for display by the head mountable display device. Implementations of the described techniques may include hardware, a method or process, or computer software on a computer-accessible medium.

While the present techniques have been described with respect to a limited number of embodiments, those skilled in the art can appreciate numerous modifications and variations therefrom. It is intended that the appended claims cover all such modifications and variations as fall within the true spirit and scope of this present techniques.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. In yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the present techniques may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

In the foregoing specification, a detailed description has been given with reference to specific embodiments. It may be evident that various modifications and changes may be made thereto without departing from the broader spirit and scope of the present techniques as set forth in the appended claims. The specification and drawings are, accordingly, to be regarded in an illustrative sense rather than a restrictive sense. Furthermore, the foregoing use of embodiment and other language does not necessarily refer to the same embodiment or the same example, but may refer to different and distinct embodiments, as well as potentially the same embodiment.

What is claimed is:

1. A curved lens apparatus for a beam guiding device comprising:
a curved lens;
a beam splitter attached to the curved lens for splitting an incident light beam into a plurality of light beams;
a coupling holographic optical element (HOE) attached to the curved lens to divert the plurality of light beams to a holographic coupling angle;
a pair of waveguide HOEs to reflect the plurality of light beams within the curved lens; and
a decoupling HOE to divert the plurality of light beams from a holographic coupling angle out of the curved lens.

2. The apparatus of claim 1, wherein the beam splitter is a diffractive optical element.

3. The apparatus of claim 1, wherein the beam splitter is a holographic optical element.

4. The apparatus of claim 1, wherein the beam splitter is mounted on a convex side of the curved lens.

5. The apparatus of claim 1, wherein the beam splitter is mounted on a concave side of the curved lens.

6. The apparatus of claim 1, wherein the waveguide HOEs comprise a first HOE that is attached to a convex side of the curved lens and a second HOE that is attached to a concave side of the curved lens.

7. The apparatus of claim 1, wherein the decoupling HOE to divert the plurality of light beams out of the curved lens to form multiple eyeboxes.

8. The apparatus of claim 1, wherein the curved lens is made of a material with a corresponding maximum total internal reflection angle, and wherein the holographic coupling angle is smaller than the internal reflection angle.

9. The apparatus of claim 1, comprising a frame to secure the curved lens, wherein incident light beam comprises a laser beam projected from the frame.

10. A method for guiding beams in a curved lens comprising:
splitting an incident light beam into a plurality of light beams with a beam splitter attached to a curved lens;
diverting, with a coupling holographic optical element (HOE) attached to the curved lens, the plurality of light beams to a holographic coupling angle;
reflecting, with a pair of waveguide HOEs, the plurality of light beams at a holographic coupling angle within the curved lens; and
diverting, with a decoupling HOE, the plurality of light beams from a holographic coupling angle out of the curved lens.

11. The method of claim 10, wherein the beam splitter is a diffractive optical element.

12. The method of claim 10, wherein the beam splitter is a holographic optical element.

13. The method of claim 10, wherein the beam splitter is mounted on a convex side of a curved lens.

14. The method of claim 10, wherein the beam splitter is mounted on a concave side of a curved lens.

15. The method of claim 10, wherein the waveguide HOEs comprise a first HOE that is attached to a convex side of the curved lens and a second HOE that is attached to a concave side of the curved lens.

16. The method of claim 10, wherein the decoupling HOE diverts the plurality of light beams out of the curved lens to form multiple eyeboxes.

17. The method of claim 10, wherein the curved lens is made of a material with a corresponding maximum total internal reflection angle, and wherein the holographic coupling angle is smaller than the internal reflection angle.

18. The method of claim 10, wherein the beam splitting and the curved lenses are secured in a frame, wherein the incident light beam comprises a laser beam projected from the frame.

19. A head mountable display system for guiding beams of light, comprising:
a frame;
an image processing integrated circuit mounted in the frame;
an optical engine mounted in the frame; and
a curved lens mounted in the frame, the curved lens comprising:
a beam splitter attached to the curved lens for splitting a light beam from the optical engine into a plurality of light beams
a coupling holographic optical element (HOE) attached to the curved lens to divert the plurality of light beams to a holographic coupling angle;
a pair of waveguide HOEs to reflect the plurality of light beams within the curved lens; and
a decoupling HOE to divert the plurality of light beams from a holographic coupling angle out of the curved lens.

20. The system of claim 19, wherein the waveguide HOEs comprise a first HOE that is attached to a convex side of the curved lens and a second HOE that is attached to a concave side of the curved lens.

21. The system of claim 19, wherein the decoupling HOE diverts the plurality of light beams out of the curved lens to form multiple eyeboxes.

22. The system of claim 19, wherein the curved lens is made of a material with a corresponding maximum total internal reflection angle, and wherein the holographic coupling angle is smaller than the internal reflection angle.

23. The system of claim 19, wherein the optical engine comprises:
a laser diode to generate a light beam; and
a micro-electro-mechanical system (MEMS) mirror to direct the light beam towards the curved lens.

24. The system of claim 19, comprising a wireless transceiver to provide data to the image processing integrated circuit for display by the head mountable display device.

25. The system of claim 24, comprising a wireless computing device to couple to the wireless transceiver to transmit image data for display by the head mountable display device.
